(19) United States
(12) Patent Application Publication
(10) Pub. No.: US 2005/0195059 A1
(43) Pub. Date: Sep. 8, 2005

(54) Inductor for computer main board

(76) Inventor: Jonas Tseng, Xinzhu Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/795,067

(22) Filed: Mar. 5, 2004

(51) Int. Cl. H01F 27/08

(52) U.S. Cl. 336/83

(57) ABSTRACT

An inductor includes a main body, a coil, and a top plate. The main body includes two opposite side plates and a coil spool mounted between the two side plates. The coil is wound around the coil spool of the main body. The top plate is mounted on the two side plates of the main body by bonding to encompass the coil. Thus, the coil is wound around the coil spool of the main body in a rectangular manner to increase the winding area of the coil, thereby enhancing the inducting effect of the coil.

### BACKGROUND OF THE INVENTION

1. Field of the Invention

The present invention relates to an inductor for a computer main board, and more particularly to an inductor, wherein the coil is wound around the coil spool of the main body in a rectangular manner to increase the winding area of the coil, thereby enhancing the inducting effect of the coil.

2. Description of the Related Art

A conventional inductor 1 for a computer main board in accordance with the prior art shown in FIGS. 4 and 5 comprises an annular body 11, and a coil 12 wound around the annular body 11. However, the winding area of the coil 12 is limited by the inner diameter of the annular body 11 as shown in FIG. 5, thereby decreasing the inducting effect of the coil 12. In addition, the winding area of the coil 12 is smaller, so that the volume of the conventional inductor 1 is increased, thereby occupying the space of the computer main board.

### SUMMARY OF THE INVENTION

The primary objective of the present invention is to provide an inductor, wherein the coil is wound around the coil spool of the main body in a rectangular manner to increase the winding area of the coil, thereby enhancing the inducting effect of the coil.

Another objective of the present invention is to provide an inductor, wherein the winding area of the coil is increased, so that the volume of the inductor can be reduced, thereby saving the space of the computer main board.

In accordance with the present invention, there is provided an inductor, comprising a main body, a coil, and a top plate, wherein:
the main body includes two opposite side plates and a coil spool mounted between the two side plates;
the coil is wound around the coil spool of the main body; and
the top plate is mounted on the two side plates of the main body by bonding to encompass the coil.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an inductor in accordance with the preferred embodiment of the present invention;

FIG. 2 is a partially exploded perspective view of the inductor in accordance with the preferred embodiment of the present invention;

FIG. 3 is a front plan cross-sectional view of the inductor as shown in FIG. 1;

FIG. 4 is a perspective view of a conventional inductor in accordance with the prior art; and

FIG. 5 is a front plan cross-sectional view of the conventional inductor as shown in FIG. 4.

### DETAILED DESCRIPTION OF THE INVENTION

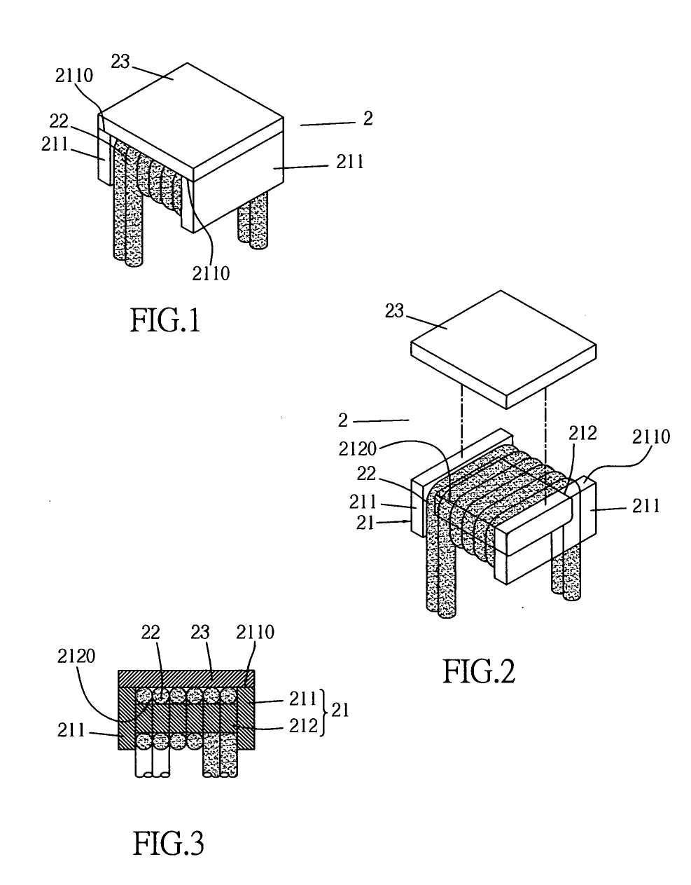

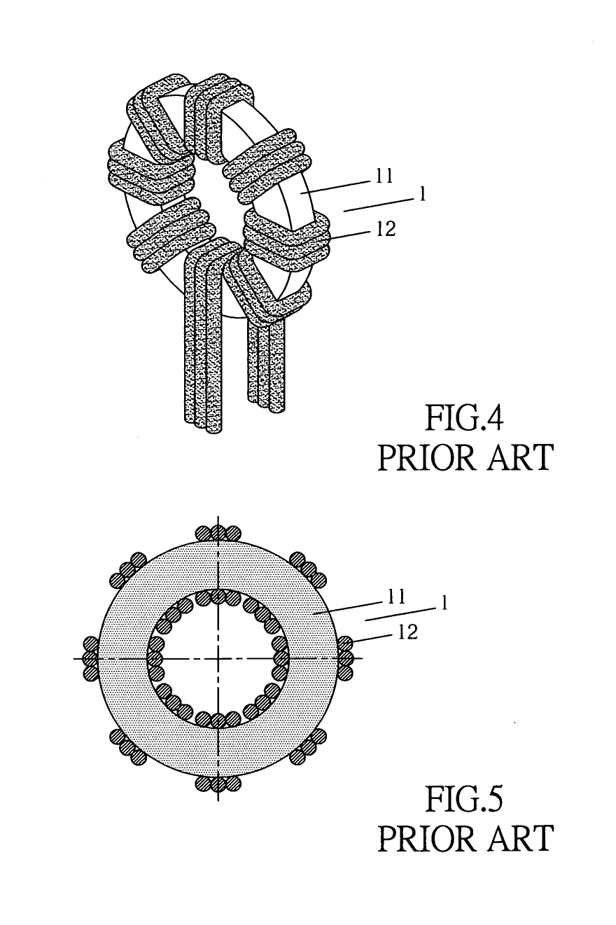

Referring to the drawings and initially to FIGS. 1-3, an inductor 2 for a computer main board in accordance with the preferred embodiment of the present invention comprises a main body 21, a coil 22, and a top plate 23.

The main body 21 has a substantially H-shaped cross-section and includes two opposite side plates 211 and a coil spool 212 mounted between the two side plates 211. Preferably, each of the two side plates 211 of the main body 21 is a rectangular plate, and the coil spool 212 of the main body 21 is also a rectangular plate.

The coil 22 is wound around the coil spool 212 of the main body 21 and located between the two side plates 211 of the main body 21.

The top plate 23 is mounted on the two side plates 211 of the main body 21 by bonding to encompass the coil 22, so that the coil 22 is enclosed between the coil spool 212 of the main body 21, the two side plates 211 of the main body 21 and the top plate 23. Preferably, the top plate 23 is a rectangular plate.

As shown in FIG. 3, the coil 22 has a diameter equal to a distance between a top face 2110 of each of the two side plates 211 of the main body 21 and a top face 2120 of the coil spool 212 of the main body 21.

Accordingly, the coil 22 is wound around the coil spool 212 of the main body 21 in a rectangular manner to increase the winding area of the coil 22, thereby enhancing the inducting effect of the coil 22. In addition, the winding area of the coil 22 is increased, so that the volume of the inductor 2 can be reduced, thereby saving the space of the computer main board.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An inductor, comprising a main body, a coil, and a top plate, wherein:
the main body includes two opposite side plates and a non-separable coil spool mounted between the two side plates;
the coil is wound around the coil spool of the main body;
the coil spool of the main body is integrally formed with the two side plates of the main body so that the main body has an integral profile having a substantially H-shaped cross-section so that the coil wound around the main body has an optimum winding area to have an optimum inducting effect; and
the top plate is mounted on the two side plates of the main body by bonding to encompass the coil.

2. (canceled)

3. The inductor in accordance with claim 1, wherein the each of the two side plates of the main body is a rectangular plate.

4. The inductor in accordance with claim 1, wherein the coil spool of the main body is a rectangular plate.

5. The inductor in accordance with claim 1, wherein the coil is closely enclosed between the coil spool of the main body, the two side plates of the main body and the top plate and has two distal ends each extended outward from the main body.

6. The inductor in accordance with claim 1, wherein the top plate is a rectangular plate.

7. The inductor in accordance with claim 1, wherein the coil has a diameter equal to a distance between a top face of each of the two side plates of the main body and a top face of the coil spool of the main body so that the coil is closely and optimally wound around the coil spool of the main body, the two side plates of the main body and the top plate.

8. The inductor in accordance with claim 1, wherein the coil is wound around the coil spool of the main body in a rectangular manner to increase the winding area of the coil.

9. The inductor in accordance with claim 1, wherein the coil is located between the two side plates of the main body.
